(19) United States
(12) Patent Application Publication
(10) Pub. No.: US 2013/0019726 A1
(43) Pub. Date: Jan. 24, 2013

(54) Food Stabilization Device, Method, and System

(71) Applicant: Richard J. Rosenbaum, Highlands Ranch, CO (US)

(72) Inventor: Richard J. Rosenbaum, Highlands Ranch, CO (US)

(21) Appl. No.: 13/185,620

(22) Filed: Jul. 19, 2011

(51) Int. Cl. A47J 43/28; B26F 1/00

(52) U.S. Cl. 83/30; 30/322

(57) ABSTRACT

A food stabilization device comprising one or more cross-bars and a plurality of teeth. The one or more cross-bars comprise at least one of a cross-bar height and a cross-bar width adapted to receive a gripping mechanism. The plurality of teeth extend from the one or more cross-bars and comprise a tip adapted to pierce one or more layers of a food item and a length adapted to at least partially reach the one or more layers of the food item.

### FIELD OF THE INVENTION

The present invention relates to food stabilization devices. In particular, but not by way of limitation, the present invention relates to substantially reducing layers of hand-held food items from shifting during eating.

### BACKGROUND OF THE INVENTION

Hand-held food items such as, but not limited to, hamburgers from fast food chains or otherwise, along with submarine sandwiches and hoagies, typically contain layers of one or more of meats, cheeses, and vegetables in-between a sliced breaded bun or other breaded pair. Often, due to the size, type, and amount of food layers between the breaded pair, in addition to lubricants such as condiments like ketchup, mustard, and mayonnaise added to the food item, the food item may become difficult to properly hold and secure while eating the food item, resulting in shifting layers in the food item. This may cause one or more layers to at least partially slide out from between the breaded pair, or have various liquids drip out of the food item due to the shifting layers. Shifting layers of the food item may also create portions of the food item having less than all the layers of the food item, creating a less-satisfying meal upon eating the portions only having partial layers.

In dealing with shifting layers in food items during eating of the food item, a person may often attempt to use two hands to stabilize the food item. However, this may be difficult for many people with small-to-medium size hands, depending on the nature of the food item. Additionally, using two hands often does not provide enough support to the food item. Furthermore, using two hands on a single food item prevents the user from enjoying additional food items such as, but not limited to, eating a french fry or taking a drink, without first putting the hand-held food item down.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

One embodiment of the invention comprises a food stabilization device comprising one or more cross-bars and a plurality of teeth. The one or more cross-bars comprise at least one of a cross-bar height and width adapted to receive a gripping mechanism. The plurality of teeth extend from the one or more cross-bars, with each of the plurality of teeth comprising a tip adapted to pierce one or more layers of a food item and a length adapted to at least partially reach each the one or more layers of the food item.

Another embodiment of the invention comprises a method of stabilizing a layered food item. One first step of a method comprises grabbing one or more cross-bars of a food stabilization device. A second step comprises piercing an outer surface of a first outer layer of the layered food item with tips of a plurality of teeth of a food stabilization device. A third step of a method comprises moving the tips past an inner surface of the first outer layer of the layered food item. A fourth step of one method comprises piercing a second layer of the layered food item with the tips.

And yet another embodiment of the invention comprises a food stabilization system. One food stabilization system comprises a top section and a bottom section. The top section may comprise one or more cross-bars, wherein the one or more cross-bars comprise at least one angle and a bottom surface. The top section may also comprise a plurality of teeth extending from the bottom surface of the one or more cross-bars. The bottom section may be rotatively coupled to the top section. Furthermore, one bottom section comprises one or more cross-bars, wherein the one or more cross-bars comprise at least one angle and a bottom surface. The bottom section may also comprise a plurality of teeth extending from the bottom surface of the one or more cross-bars.

### BRIEF DESCRIPTION ON THE DRAWINGS

Various objects and advantages and a more complete understanding of the present invention are apparent and more readily appreciated by reference to the following Detailed Description and to the appended claims when taken in conjunction with the accompanying Drawings, where like or similar elements are designated with identical reference numerals throughout the several views and wherein:

FIG. 1 illustrates an exemplary embodiment of a food stabilization device;

FIGS. 2A and 2B illustrate an exemplary embodiment of a food stabilization device inserted in a food item;

FIG. 3 illustrates a method that may be carried out in connection with the embodiments described herein;

FIG. 4 illustrates an exemplary embodiment of a food stabilization system.

### DETAILED DESCRIPTION

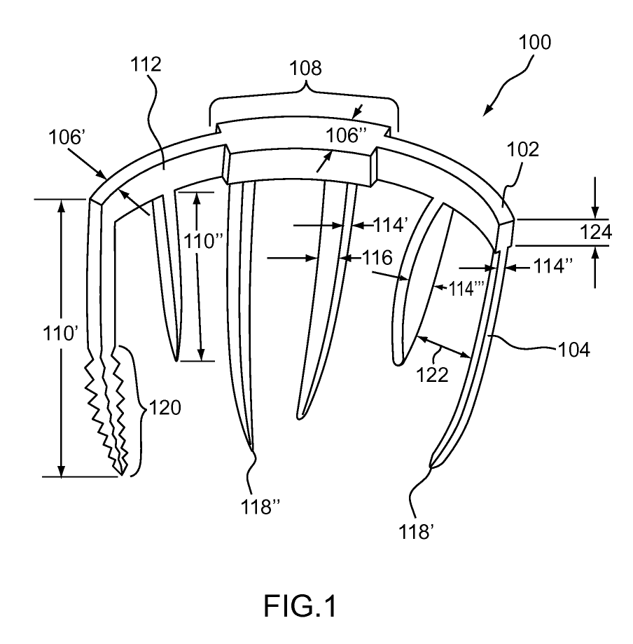

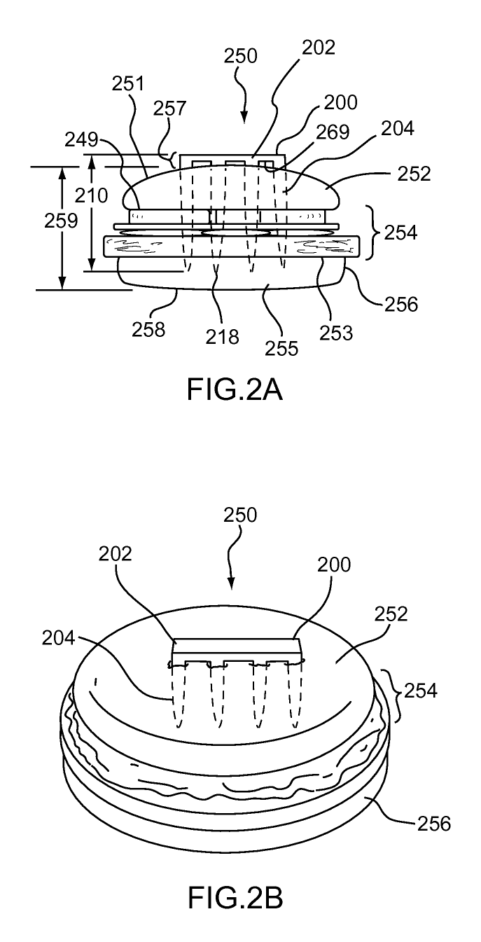

Turning first to FIG. 1, seen is one embodiment of a food stabilization device 100 comprising one or more cross-bars 102 and a plurality of teeth 104 which may be integrated or coupled to the one or more cross-bars 102. The one or more cross-bars 102 may comprise a single cross-bar, as seen in FIG. 1. Other embodiments having multiple generally parallely-aligned and non-parallely-aligned crossbars are also contemplated. One cross-bar 102 comprises a height 124 and width 106 adapted to receive a gripping mechanism. For example, the height 124 and width 106 may be adapted for a person to grip the cross-bar 102 between the person's forefinger and thumb. Other gripping mechanisms are also contemplated. In one embodiment, the plurality of teeth 104 extend outwardly away from the one or more cross-bars 102. Each of the plurality of teeth 104 may comprise a tip 118 adapted to pierce one or more layers of a food item such as, but not limited to the food item 250 seen in FIGS. 2A and 2B. The plurality of teeth 104 also comprise one or more lengths 110 adapted to at least partially reach each the one or more layers of the food item 250.

The width 106 and height 124 of the cross-bar 102 may be adapted for one or more food types. In one embodiment, the food stabilization device 100 may comprise at least one of a first width 106″ and a second width 106′, with the first width 106″ being greater than the second width 106′. A larger width 106 which may be needed to provide a greater stability to food items 250 having a larger number of layers. In one embodiment, the second width 106′ may be about ⅛-¼ of an inch and the first width 106″ may be about ½-¾ of an inch. Furthermore, the smaller second width 106′ may be adapted for use with narrower food items such as, but not limited to, hot dogs, while the larger first width 106″ may be adapted for use with wider sandwiches such as, but not limited to, hamburgers. In one embodiment, at least a portion the width 106 may comprise a diameter.

The one or more cross-bars 102 may comprise a straight cross-bar 102 or the one or more crossbars 102 may comprise at least one angle. For example, in FIG. 1, the cross-bar 102 comprises a curved crossbar having a single arc spanning the length of the cross-bar 102. The cross-bar may also comprise a substantially 90° right-angle between two straight cross-bar 102 sections. Other cross-bar designs are also contemplated, such, but not limited to, two or more straight or curved cross-bar sections having acute or obtuse angles between the sections. Substantially circular cross-bars 102 or a cross-bar 102 having any other shape known in the art is also contemplated.

In one embodiment, at least some of the plurality of teeth 104 are coupled to a center portion 108 of the one or more cross-bars 102 and extend from a bottom surface 269 of the crossbar 102, as seen in FIG. 2. The one or more lengths 110 of the plurality of teeth 104 may comprise a first length 110′ and a second length 110″, with the first length 110′ being longer than the second length 110″. The one or more lengths 110 may be adapted for one or more food types. For example, the first length 110′ may be adapted for a thicker food item such as, but not limited to, a hamburger, while the second length 110″ may be adapted for a thinner food item such as, but not limited to, a Panini. Having multiple lengths of the plurality of teeth 104 in a single food stabilization device 100 may increase the stability of the food item. In one embodiment, at least one of the one or more lengths 110 may comprise a length of about 1.5 inches to about 4 inches. However, shorter lengths of 0.5 inches to 1 inch and longer lengths of about 4 to 6 inches are also contemplated.

As seen in FIGS. 1 and 2, the plurality of teeth 104 may extend generally perpendicularly and longitudinally away from the bottom surface 269 of the one or more cross-bars 102. The plurality of teeth 104 may have a slight curve to them as well. In one embodiment, the plurality of teeth 104 may be slightly curved towards a front surface 112 of the one or more cross bars 102. It is also contemplated that the plurality of teeth 104 may comprise more than one curve and the curves may be more pronounced than the curve in the cross-bar 102 in FIG. 1, and that the plurality of teeth 104 may extend from a surface other than the bottom surface 269. For example, the plurality of teeth 104 may extend from the front surface 112 and comprise an angle to so the teeth 102 point generally downward.

In one embodiment, the width 106 of the one or more cross-bars 102 may be substantially similar to a width 114 and/or a thickness 116 of the plurality of teeth 104. It is also contemplated that the width 114 and thickness 116 of the plurality of teeth 104 may comprise a diameter. One embodiment comprises a first width 114′ and a second width 114″, with the second width 114″ being smaller than the first width 114′. The various widths and/or thicknesses of the plurality of teeth 104 may be adapted for use with various food items. For example, a thicker width 114 may be adapted for harder and/or denser food item layers while thinner widths 114 may be adapted for softer and/or less dense food item layers. Additionally, it is contemplated that one or more of the plurality of teeth 104 may comprise varied width 114 or thickness 116. For example, one width 114 may comprise a bulging width 114″′, whereby a center portion of at least one of the plurality of teeth 104 comprises a larger width 114 than the end portions of the one of the plurality of teeth 104, with the increase from the end portions to the center portion being gradual in one embodiment, but in other embodiments, may have a step-increase in widths 114.

Seen in FIGS. 2A and 2B is one example of a food item 250 with a food stabilization device 200 stabilizing the food item 250. The food item in FIGS. 2A and 2B comprises a first outer breaded layer 252, at least one inner layer 254 and a second outer breaded layer 256. The first outer breaded layer 252 and second outer breaded layer 256 may be referenced to the first outer layer 252 and second outer layer 256, respectively. The first and second outer breaded layers 254, 456 may also comprise non-breaded layers. The food stabilization device 200 seen in FIGS. 2A and 2B comprises a plurality of teeth 204 having a length 210 adapted to extend from an outer surface 251 of the first outer breaded layer 252, through the at least one inner layer 254, through an inner surface 253 of the second outer breaded layer 256, and into a middle portion 255 of the second outer breaded layer 256. It is to be appreciated that an upper portion 257 of the food stabilization device 200 may extend beyond the outer surface 251 of the first outer breaded layer 252. A portion of the plurality of teeth 204 may be included in the upper portion 257. In one embodiment, the bottom surface 269 of the crossbar 202 may rest against the outer surface. The amount of the food stabilization device 200 comprising the upper portion 257 may differ depending on the thickness 259 of the food item 250. For example, thicker food items 250 may comprise a smaller upper portion 257, while thinner food items 250 may comprise a larger upper portion 257, as a user may not wish to have the tips 218 exposed on the outside of the second breaded layer 256.

Returning now to FIG. 1, it is to be appreciated that the tips 118 of the plurality of teeth may comprise rounded tips 118′ as opposed to pointed tips 118″, so that if the tips are encountered on the inside of the food item 250 by a person's mouth either during eating the food item 250, or because the tips 118 protrude beyond an outer surface 258 of the second breaded layer 256, the person is less likely to be injured. However, the tips 118 should be adapted, through shape or otherwise, to pierce the outer surface 251 of the first breaded layer 252, as well as the one or more inner layers 254 and the inner surface 253 of the second outer breaded layer 256 without sufficient force to squeeze the food item layers together. It is to be appreciated that the food stabilization device 200 may only be placed into the food item 250 to a depth such that the tips 118 of the food stabilization device 200 remain within the food item 250 and may not protrude beyond the outer surface 258 of the second breaded layer 256. Furthermore, as seen in FIG. 1, at least a portion of at least one of the plurality of teeth 104 may comprise serrations 120, which may be adapted to enable the food stabilization device 100 to prevent layers in the food item 250 from shifting such as, but not limited to, rotating and sliding out from between the two outer breaded layers.

The food stabilization device 100 may further comprise a distance 122 between the plurality of teeth 104. The distance 122 may be varied and/or increase towards the tips 118, potentially as the widths 114 and/or thickness 116 decreases. The distance 122 is adapted to enable the food stabilization device 100 to properly secure the food layers of the food item 250. However the distance 122, along with the width 114 and thickness 116 of the plurality of teeth should be adapted to prevent the food stabilization device 100 from cutting the food item 250 into two or more separate sections. For example, in one embodiment, the distance 122 may be proportional to the size of the width 114 and/or thickness 116 of the plurality of teeth 104. Therefore, a food stabilization device 100 having a larger teeth width 114 and/or thickness 116 may also comprise a larger distance 122, where a food stabilization device 100 having a smaller width 114 and/or thickness 116 may comprise a shorter distance 122. In one embodiment, the distance 122 may be larger than the width 114 and/or thickness 116. For example, the distance 122 may comprise three times (3×) the width 114 in one embodiment. One distance 122 may comprise about ⅓ an inch and one width may comprise from about 1/16 of an inch to about ⅛ of an inch.

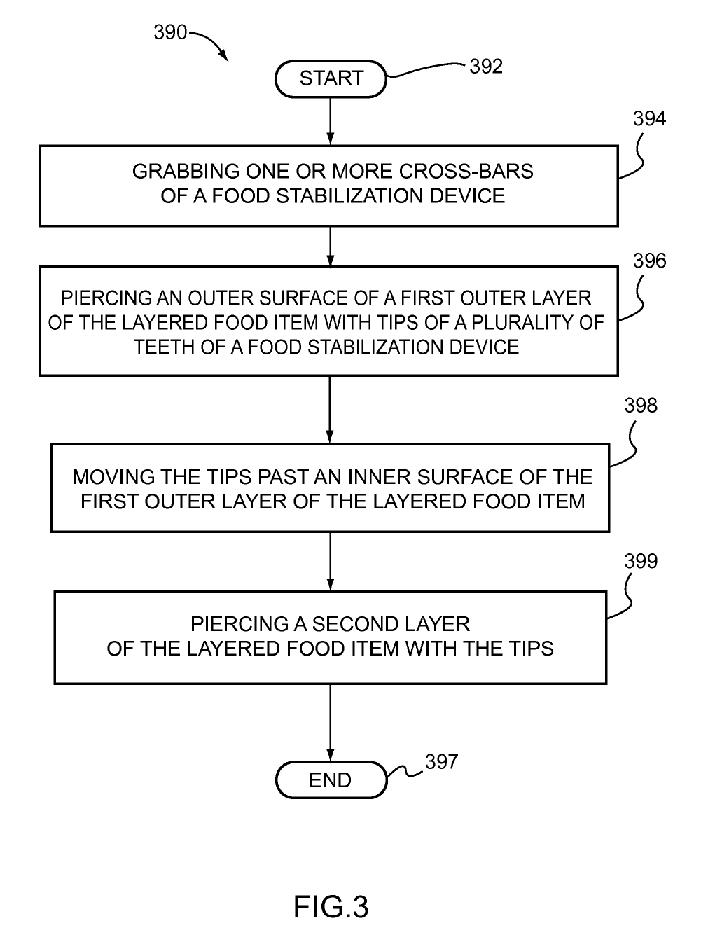

Turning now to FIG. 3, seen is a method 390 of stabilizing a layered food item. One method 390 starts at 392 and at 394 comprises grabbing one or more cross-bars of a food stabilization device. AT 396 the method comprises piercing an outer surface of a first outer layer of the layered food item with tips of a plurality of teeth of a food stabilization device. For example, a person may place the one or more cross bars 102 between a thumb and forefinger and place the tips 116 of the plurality of teeth 104 of the food stabilization device 100 of FIG. 1 against the outer surface 251 of the first outer breaded layer 252 of the food item 250. A longitudinal axis of the plurality of teeth 204 may be substantially perpendicular to the outer surface 251 in one embodiment upon placement of the tips against the outer surface 251. However, in other embodiments, the longitudinal axis of the plurality of teeth 204 may not be perpendicular to the outer surface 251. In either event, upon placement of the tips 218 against the outer surface 251, by moving the one or more crossbars 102 toward the outer surface 251, the tips 118 of the plurality of teeth 104 of the food stabilization device 100 seen in FIG. 1 may be used to pierce the outer surface 251 of the first outer breaded layer 252, as seen in FIGS. 2A and 2B.

At 398 the method comprises moving the tips 118 past an inner surface 249 of the first outer breaded layer 252 of the layered food item. For example, the tips 118 may be moved from the outer surface 251, through the first outer breaded layer 252 and the inner surface 249, and into the at least one inner layer 254. In one embodiment, the at least one inner layer 254 comprises a second layer such as, but not limited to, a meat layer of the food item 250. In moving the tips 118 into the second layer, and as seen in 398, one method 390 comprises piercing a first surface of the second layer of the layered food item 250 with the tips 218.

Though not seen in FIG. 3, one method 390 may further comprise placing at least a portion of the one or more cross-bars 202 against the outer surface 252 of the outer layer 251 of the layered food item. As seen in FIG. 2B, the cross-bar 202 may be placed flush against the outer surface, thereby providing additional stability to the food item 250, securing the plurality of teeth 204. The method 390 may end at 397. The method 390 may further comprise placing a longitudinal axis of the plurality of teeth 204 substantially perpendicularly against the outer surface 251 of the first outer layer 252 of the layered food item 250 prior to piercing the outer surface 251 of the first outer layer 252 of the layered food item 250 with the tips 218 of the plurality of teeth 204.

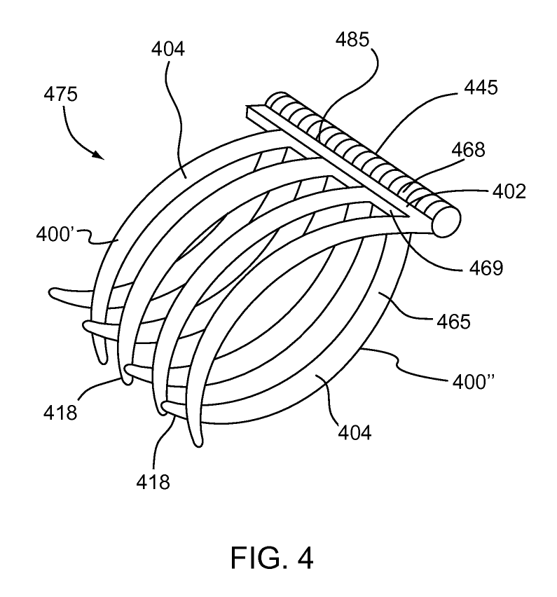

Turning now to FIG. 4, seen is a food stabilization system 475. One food stabilization system 475 comprises a pair of opposingly coupled food stabilization devices 400 described above. For example, a first food stabilization device 400′ of the food stabilization system 475 comprises a first section comprising top section 485 and a second food stabilization device 400″ comprises a second section comprising bottom section 465. Each of the top section 485 and bottom section 465 comprises one or more cross-bars 402 and a plurality of teeth 404. Furthermore, the cross bar 402 of the top section 485 and bottom section 465 may also comprise a bottom surface 469, with a plurality of teeth 404 extending from the bottom surface 469 of the one or more cross-bars 402. As seen, the plurality of teeth 404 may be curved. The bottom section 465 may be rotatively coupled to the top section 485 through the use of at least one biasing device 468 such as, but not limited to, a spring. It is to be appreciated that the one or more cross-bars 402 of the top section 485 and bottom section 465 may each comprise a single crossbar 402. Furthermore, the at least one angle in the crossbar 402 may comprise a single curve running lengthwise across the crossbar 402. One system 475 is adapted to create an opening between the tips 418 of the first and second plurality of teeth 404. For example, the tips 418 may be pulled apart and the food item may be placed between them. In letting go of the tips 418, the biasing device 468 may rotatively push the tips 418 together, with the tips 418 piercing one or more layers. It is also contemplated that the tips 418 of one of the top section 485 and the bottom section 465 may be adapted to couple to the other of the top section 485 and bottom section 465. For example, one of the top section 485 and bottom section 465 may be adapted to receive the tips 418 of the other of the top section 485 and bottom section 465. In one embodiment, the tips 418 of the top section 485 may be adapted to snap into the bottom section 465. One such bottom section 465 may comprise a horizontal bar substantially parallel to a base section 445 and crossbar 402. The horizontal bar may be adapted to rest on the outer surface 258 of the second breaded layer 256, as seen in FIG. 2, in order to receive the tips 418.

In conclusion, embodiments of the present invention enable the stabilization of food items. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A food stabilization device comprising,
or more cross-bars, wherein the one or more cross-bars comprise at least one of a cross-bar height and a cross-bar width adapted to receive a gripping mechanism; and
a plurality of teeth extending from the one or more cross-bars, wherein each of the plurality of teeth comprise,
a tip adapted to pierce one or more layers of a food item, and
a length adapted to at least partially reach the one or more layers of the food item.

2. The food stabilization device of claim 1 wherein,
the cross-bar width and cross-bar height are adapted for one or more food types; and
the plurality of teeth,
are coupled to at least one of,
a center portion of the one or more cross-bars, and
a bottom surface of the one or more cross-bars.

3. The food stabilization device of claim 2, wherein,
the cross-bar width comprises at least one of a first width and a second width, the first width being larger than the second width;
the length of the plurality of teeth comprise at least a first length and a second length, the first length being longer than the second length;
the food type comprises at least,
a first outer breaded layer,
one inner layer, and
a second outer breaded layer; and
the plurality of teeth extend generally perpendicularly and longitudinally away from the bottom surface.

4. The food stabilization device of claim 3 wherein, the plurality of teeth comprising the first length are adapted to at least pierce an inner surface of the second outer breaded layer.

5. The food stabilization device of claim 1 wherein,
the plurality of teeth comprise serrations; and
the length is about 1.5 inches to about 4 inches.

6. The food stabilization device of claim 1 wherein, the one or more cross-bars comprise,
at least one curved section; and
at least one of a first width and a second width, wherein the first width,
comprises a width greater than the second width; and
provides a greater stability to a layered food item than the second width.

7. The food stabilization device of claim 6 wherein the first width is about ½-¾ inches and the second width is about ⅛-¼ inches.

8. The food stabilization device of claim 1 further comprising, a distance between the plurality of teeth at least as large as at least one of a width and a diameter of the plurality of teeth.

9. The food stabilization device of claim 8 wherein,
the distance between the plurality of teeth comprise a distance of at least ⅓ an inch; and
the one of a width and a diameter of the plurality of teeth is from about 1/16 of an inch to about ⅛ of an inch.

10. A method of stabilizing a layered food item comprising,
grabbing one or more cross-bars of a food stabilization device;
piercing an outer surface of a first outer layer of the layered food item with tips of a plurality of teeth of the food stabilization device;
moving the tips past an inner surface of the first outer layer of the layered food item; and
piercing a second layer of the layered food item with the tips.

11. The method of claim 10 wherein,
the plurality of teeth comprise at least,
one of a first width and second width, and
one of a first length and a second length;
the one of a first width and second width comprises a width adapted for one of a first food item type and a second food item type; and
the one of a first length and a second length comprises a length for one of the first food item type and the second food item type.

12. The method of claim 11 wherein,
the first width comprises a width greater than the second width;
the first length comprises a length longer than the second length; and
the first food item type comprises at least one of a wider and a deeper food item than the second food item type.

13. The method of claim 10 further comprising, placing at least one of the one or more cross-bars proximal the outer surface of the first outer layer of the layered food item

14. The method of claim 10 further comprising, placing a longitudinal axis of the plurality of teeth substantially perpendicularly against the outer surface of the first outer layer of the layered food item prior to piercing the outer surface of the first outer layer of the layered food item with the tips of the plurality of teeth.

15. The method of claim 10 wherein,
the layered food item comprises one of a deli sandwich and a hamburger; and
further comprising,
eating the one of a deli sandwich and hamburger.

16. A food stabilization system comprising,
a top section comprising,
one or more cross-bars, wherein the one or more cross-bars comprise,
at least one angle, and
a bottom surface, and
a plurality of teeth extending from the bottom surface of the one or more cross-bars; and
a bottom section rotatively coupled to the top section, wherein the bottom section comprises,
one or more cross-bars, wherein the one or more cross-bars comprise,
at least one angle, and
a bottom surface, and
a plurality of teeth extending from the bottom surface of the one or more cross-bars.

17. The food stabilization system of claim 16 wherein, the at least one of the one or more cross-bars of the bottom section is coupled to at least one of the one of more cross-bars of the top section with a biasing device.

18. The food stabilization system of claim 17, wherein the biasing device comprises a spring.

19. The food stabilization system of claim 17 wherein the one or more cross-bars comprises a single crossbar.

20. The food stabilization system of claim 16 wherein, the at least one angle comprises a single curve running lengthwise across the one or more crossbars.
